(19) United States
(12) Patent Application Publication
(10) Pub. No.: US 2025/0309257 A1
(43) Pub. Date: Oct. 2, 2025

(54) SODIUM ION BATTERY CATHODE MATERIAL AND PREPARATION METHOD THEREOF AND SODIUM ION BATTERY

(71) Applicant: BEIJING EASPRING MATERIAL TECHNOLOGY CO., LTD., Beijing (CN)

(72) Inventors: Feijiang CHEN, Beijing (CN); Yafei LIU, Beijing (CN); Yanbin CHEN, Beijing (CN)

(21) Appl. No.: 19/237,043

(22) Filed: Jun. 13, 2025

Related U.S. Application Data
(63) Continuation of application No. PCT/CN2023/116267, filed on Aug. 31, 2023.

(51) Int. Cl. H01M 4/525; C01G 53/51; H01M 4/02

(52) U.S. Cl. CPC H01M 4/525; C01G 53/51; C01P 2002/50; C01P 2002/72; C01P 2004/03; C01P 2004/64; C01P 2006/11; C01P 2006/40; H01M 2004/021

(57) ABSTRACT

The present application relates to the technical field of sodium-ion batteries, in particular to a sodium ion battery cathode material, a preparation method thereof, and a sodium ion battery, in an XRD spectrogram of the cathode material, the characteristic diffraction peak A of (003) crystal plane and the characteristic diffraction peak B of (104) crystal plane are arranged at 2θ of 15-19° and 39-44°, respectively; wherein the microcrystalline size D_{A} of the characteristic diffraction peak A and the microcrystalline size D_{B} of the characteristic diffraction peak B satisfy the following condition: 1.3≤D_{A}/D_{B}≤2.5, wherein D_{A} and D_{B} correspond to the microcrystalline sizes of the (003) crystal plane and the (104) crystal plane in the perpendicular line direction, respectively.

### CROSS REFERENCE TO RELATED APPLICARTIONS

The application is a continuation of International Patent Application No. PCT/CN2023/116267 filed on Aug. 31, 2023, entitled “sodium ion battery cathode material and preparation method thereof and sodium ion battery”, the content of which is specifically and entirely incorporated herein by reference.

### FIELD

The present application relates to the technical field of sodium-ion batteries, in particular to a sodium ion battery cathode material, a preparation method thereof, and a sodium ion battery containing the sodium ion battery cathode material.

### BACKGROUND

Lithium-ion batteries have been widely used in large quantities in the new energy vehicle industry in recent years along with the booming production and use of electric vehicles, however, the price of lithium resources is continuously and rapidly rising, it causes that the resource-rich and inexpensive sodium ion batteries have attracted the wide-spread attention, because the sodium ion battery techniques can dramatically reduce the costs of battery manufacture, and are expected to gain a large-scale application in the low-speed electric vehicles and energy storage fields.

In the sodium ion battery system, the layered oxide (NaₓMO₂, M=Ni, Fe, Mn, etc.) are currently the cathode materials that can balance the application requirements of the power impetus and energy storage battery and have advantages such as low cost, excellent low-temperature properties, high thermal stability, desirable safety performance, high energy density, and environmental friendliness. The layered oxide exhibits enormous potential in middle-low end passenger vehicles, energy storage batteries, and other markets.

However, the NaₓMO₂ material is not only very sensitive to air humidity, prone to absorb water and convert into other compounds, resulting in poor air stability, but also suffers from large volumetric change along with the Na⁺ intercalation/de-intercalation structure during the charging and discharging process, which causes structural collapse and degraded cycle stability of the sodium ion batteries. Therefore, the present application aims to investigate and solve the problem concerning how to overcome the above-mentioned deficiencies of the NaₓMO₂ material and improve air stability and structural stability.

### SUMMARY

The present application intends to overcome the aforementioned technical problems and provides a sodium ion battery cathode material and a preparation method thereof, and a sodium ion battery, the cathode material has improved air stability and structural stability on the premise of ensuring a high volume energy density; in addition, a use of the cathode material in the sodium ion battery can effectively improve the electrochemical properties of the sodium ion battery.

In order to achieve the above objects, the first aspect of the present application provides a sodium ion battery cathode material, in an X-Ray Diffraction (XRD) spectrogram of the cathode material, the characteristic diffraction peak A of (003) crystal plane and the characteristic diffraction peak B of (104) crystal plane are arranged at 2θ of 15-19° and 39-44°, respectively;
wherein the microcrystalline size D_{A} of the characteristic diffraction peak A and the microcrystalline size D_{B} of the characteristic diffraction peak B satisfy the following condition: 1.3≤D_{A}/D_{B}≤2.5, wherein D_{A} and D_{B} correspond to the microcrystalline sizes of the (003) crystal plane and the (104) crystal plane in the perpendicular line direction, respectively.

Unless otherwise specified in the present application, the sodium ion battery cathode material is abbreviated as “cathode material”.

Preferably, the cathode material has an O3-type monocrystal structure, and the c value is selected from the range of 16-16.1 Å.

Preferably, the cathode material has the composition represented by formula I: Naₐ(NiₓFe_{y}Mn_{z}MₘM′ₙ)O₂ (I), in formula I, 0.8≤a≤1.1, 0≤x≤0.5, 0≤y≤0.5, 0≤z≤0.5, 0≤m≤0.5, 0≤n≤0.2, 0.05≤m+n≤0.5, m and n are not simultaneously 0, x+y+z+m+n=1; M and M′ are each independently at least one element selected from the group consisting of Li, Cu, Co, V, Cr, Ti, Mg, Sn, Zn, Al, Zr, Sr, Nb, B, Y, W, and La.

The second aspect of the present application provides a method for preparing a sodium ion battery cathode material, comprising the following steps:
(1) pre-sintering a precursor having the composition represented by formula (II) Ni_{α}Fe_{β}Mn_{γ}M_{δ}OₐH_{b} to obtain a pre-sintered precursor;
(2) mixing and calcinating the pre-sintered precursor, a Na source, and an optional M′-containing dopant to obtain a cathode material; wherein M and M′ in the cathode material are not simultaneously 0;
wherein in formula II, 0≤α≤0.5, 0≤β≤0.5, 0≤γ≤0.5, 0≤δ≤0.5, 1≤a≤2, 0≤b≤2, α+β+γ+δ=1, M and M′ are each independently at least one element selected from the group consisting of Li, Cu, Co, V, Cr, Ti, Mg, Sn, Zn, Al, Zr, Sr, Nb, B, Y, W, and La;
wherein the pre-sintering comprises first temperature rise stage, second temperature rise stage and heat preservation stage, the conditions of the first temperature rise stage comprise: raising the temperature to T₁ at a temperature-rise rate v₁ in an oxygen-depleted atmosphere having an oxygen concentration less than or equal to 10 vol %; the conditions of the second temperature rise stage comprise: raising the temperature to T₂ at a temperature-rise rate v₂ in an oxygen-depleted atmosphere having an oxygen concentration less than or equal to 20 vol %; the conditions of the heat preservation stage comprise: preserving heat within the temperature range of (T₂−10)≤T≤(T₂+10) for a time t; wherein v₁ is selected from the range of 5-10° C./min, v₂ is selected from the range of 1-3° C./min, T₁ is selected from the range of 200-300° C., T₂ is selected from the range of 450-750° C.; t is selected from the range of 3-10 h.

The third aspect of the present application provides a sodium ion battery comprising the cathode material provided in the first aspect or the cathode material produced with the method provided in the second aspect.

### BRIEF DESCRIPTION OF THE DRAWINGS

FIG. 1 is a Scanning Electron Microscope (SEM) spectrogram of the precursor produced in Example 1.

FIG. 2 is an SEM spectrogram of the pre-sintered precursor produced in Example 1.

FIG. 3 shows an SEM spectrogram of the O3-type monocrystal cathode material S1 produced in Example 1.

FIG. 4 illustrates an X-Ray Diffraction (XRD) pattern of the precursor produced in Example 1.

FIG. 5 illustrates an XRD pattern of the pre-sintered precursor produced in Example 1.

FIG. 6 shows an XRD pattern of the O3-type monocrystal cathode material S1produced in Example 1.

### DETAILED DESCRIPTION

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed have been specifically disclosed herein.

Unless otherwise specified in the present application, the expressions “first” and “second” neither represent the sequential order nor impose a limiting function on the materials or steps, the expressions are merely used for distinguishing or indicating that they are not the same materials or steps. For example, the terms “first temperature rise stage” and “second temperature rise stage” are used exclusively to indicate that they are not the same temperature rise stages.

The first aspect of the present application provides a sodium ion battery cathode material, in an XRD spectrogram of the cathode material, the characteristic diffraction peak A of (003) crystal plane and the characteristic diffraction peak B of (104) crystal plane are arranged at 2θ of 15-19° and 39-44°, respectively;
wherein the microcrystalline size D_{A} of the characteristic diffraction peak A and the microcrystalline size D_{B} of the characteristic diffraction peak B satisfy the following condition: 1.3≤D_{A}/D_{B}≤2.5, wherein D_{A} and D_{B} correspond to the microcrystalline sizes of the (003) crystal plane and the (104) crystal plane in the perpendicular line direction, respectively.

Unless otherwise specified in the present application, the microcrystalline structural features (e.g., D_{A} and D_{B}) refer to the vertical distance from the crystal plane to the microcrystalline center. For example, D_{A} denotes the vertical distance from the (003) crystal plane to the microcrystalline center; and D_{B} denotes the vertical distance from the (104) crystal plane to the microcrystalline center.

In the present application, the microcrystalline size is measured through the following method: the comprehensive analysis software JADE 6.5 for powder X-ray diffraction patterns is used, the powder X-ray diffraction patterns are measured and obtained from the powder X-ray diffraction, and the half-peak widths of the characteristic diffraction peak A appeared at the range of 2θ=15-19° and the characteristic diffraction peak B appeared at the range of 2θ=39-44° are obtained respectively; the obtained half-peak widths are used for calculating the microcrystalline size D_{A} and the microcrystalline size D_{B} respectively according to the Scherrer formula.

In the present application, the larger the D_{A}/D_{B} ratio, it indicates the larger the size difference of the microcrystalline sizes in different directions, and the microcrystallite is grown anisotropically; if the D_{A}/D_{B} ratio is closer to 1, it demonstrates that the microcrystalline sizes are proximate in different directions, the microcrystallite is grown isotropically. When the microcrystal volumes are the same, the degree of anisotropic growth of the microcrystallites will influence the sodium ion de-intercalation and the microcrystallite stability. Therefore, the present application defines 1.3≤D_{A}/D_{B}≤2.5, such that Na⁺ travels a shorter distance during the charging and discharging process, and can be transmitted more easily, thereby improving the rate performance of the sodium ion battery.

In some embodiments of the present application, the cathode material preferably has an O3-type monocrystal structure, and the c value is selected from the range of 16-16.1 Å. In the present application, by defining the c value range, indicating that the cathode material has a smaller interlayer spacing, the air-borne water and carbon dioxide enter the interlayer to react with Na when the material is exposed to an environment having a higher relative humidity is largely suppressed, and the air stability of the material is significantly improved.

In the present application, the term “O3-type monocrystal structure” refers to the monocrystal cathode material with a crystalline form of O3-type, i.e., the cathode material has O3-type sodium electron layered oxide crystal cell structural parameters.

Unless otherwise specified in the present application, the characteristic diffraction peak A has a separate broad peak for an angle 2θ within the range of 15-19°, and the characteristic diffraction peak B has a separate broad peak for an angle 2θ within the range of 39-44°.

In some embodiments of the present application, preferably, in an XRD spectrogram of the cathode material, the characteristic diffraction peak A has an angle 2θ within the range of 16.5±1°, and the characteristic diffraction peak B has an angle 2θ within the range of 41.5±1°.

In a specific embodiment of the present application, when the cathode material is subjected to an X-ray diffraction assay by using CuKα rays, the microcrystalline size D_{A} of the characteristic diffraction peak A having an angle 2θ within the range of 16.5±1° and the microcrystalline size D_{B} of the characteristic diffraction peak B having an angle 2θ within the range of 41.5±1° satisfy the following condition: 1.3≤D_{A}/D_{B}≤2.5.

In some embodiments of the present application, the microcrystalline size D_{A} of the characteristic diffraction peak A and the microcrystalline size D_{B} of the characteristic diffraction peak B satisfy the following condition: 1.3≤D_{A}/D_{B}≤2.5, e.g., 1.3, 1.5, 1.8, 2, 2.5, and a random value within the range consisting of any two numerical values thereof, preferably 1.3≤D_{A}/D_{B}≤2. The numerical values satisfying the preferred ranges are more conducive to improving the volumetric energy density, air stability, and structural stability of the cathode material.

In some embodiments of the present application, the cathode material preferably has the composition represented by formula I: Naₐ(NiₓFe_{y}Mn_{z}MₘM′ₙ)O₂ (I), in formula I, 0.8≤a≤1.1, 0≤x≤0.5, 0≤y≤0.5, 0≤z≤0.5, 0≤m≤0.5, 0≤n≤0.2, 0.05≤m+n≤0.5, m and n are not simultaneously 0, x+y+z+m+n=1; M and M′ are each independently at least one element selected from the group consisting of Li, Cu, Co, V, Cr, Ti, Mg, Sn, Zn, Al, Zr, Sr, Nb, B, Y, W, and La.

In some embodiments of the present application, further preferably, in formula I, 0.85≤a≤1.05; furthermore preferably, 0.93≤a≤1.03.

In some embodiments of the present application, further preferably, in formula I, M is at least one element selected from the group consisting of Cu, Co, V, Cr, Ti, Mg, Sn, Zn, Al, Zr, Nb, Y, W, and La, and M′ is at least one element selected from the group consisting of Li, Al, Mg, Ti, Zr, Sr, La, Nb, B, and W; furthermore preferably, M and M′ are different.

In some embodiments of the present application, preferably, average partice size D₅₀ of the cathode material is within the range of 7-20 μm, preferably within the range of 8-16 μm, more preferably within the range of 9-12 μm.

In the present application, the cathode material has a wider particle size distribution. Preferably, the particle size distribution of the cathode material satisfies the following condition: 1.2≤(D₉₀−D₁₀)/D₅₀≤1.8, for example, 1.2, 1.4, 1.5, 1.6, 1.8, and a random value within the range consisting of any two numerical values thereof, preferably 1.4≤(D₉₀−D₁₀)/D₅₀≤1.6. The particle size distribution satisfying the preferred ranges are more conducive to improving the compaction density and volume energy density of the cathode material.

In some embodiments of the present application, preferably, the compaction density of the cathode material is within the range of 3-3.6 g/cm³, for example, 3 g/cm³, 3.3 g/cm³, 3.4 g/cm³, 3.5 g/cm³, 3.6 g/cm³, and a random value within the range consisting of any two numerical values thereof, more preferably within the range of 3.3-3.6 g/cm³.

In some embodiments of the present application, preferably, the water increment of the cathode material satisfies the following condition: 0%≤Δ(H₂O)≤120%, wherein Δ(H₂O)=H₂O(tₓ−t₀)/H₂O(t₀), 0 h<tₓ≤6 h, t₀=0 h; more preferably 0%≤Δ(H₂O)≤100%.

In some embodiments of the present application, preferably, the residual alkali conversion rate of the cathode material satisfies the following condition: 0%≤Δ(Na₂CO₃+NaOH)≤200%, wherein Δ(Na₂CO₃+NaOH)=Na₂CO₃(tₓ−t₀)/Na₂CO₃(t₀)+NaOH(tₓ−t₀)/NaOH(t₀), 0 h<tₓ≤6 h, t₀=0 h; more preferably 0%≤Δ(Na₂CO₃+NaOH)≤150%.

When the cathode material has a large interlayer spacing, the water and carbon dioxide in the air can easily enter the laminate structure and react with Na, resulting in the increased water absorption quantity of the material, and the increased conversion quantities of Na₂CO₃ and NaOH, and the showing of the large shift forward of the (003) crystal plane diffraction peak. In the present application, the cathode material provided by the present application has a reasonable interlayer spacing, which ensures that the sodium ion intercalation/de-intercalation is easier, and can prevent the water and carbon dioxide in the air from entering the laminate structure, so that the water absorption in air is smaller, and the conversion quantities of Na₂CO₃ and NaOH are reduced. Therefore, the cathode material provided by the present application has excellent air stability.

The second aspect of the present application provides a method for preparing a sodium ion battery cathode material, comprising the following steps:
(1) pre-sintering a precursor having the composition represented by formula (II) Ni_{α}Fe_{β}Mn_{γ}M_{δ}OₐH_{b} to obtain a pre-sintered precursor;
(2) mixing and calcinating the pre-sintered precursor, a Na source, and an optional M′-containing dopant to obtain a cathode material; wherein M and M′ in the cathode material are not simultaneously 0;
wherein in formula II, 0≤α≤0.5, 0≤β≤0.5, 0≤γ≤0.5, 0≤δ≤0.5, 1≤a≤2, 0≤b≤2, α+β+γ+δ=1, M and M′ are each independently at least one element selected from the group consisting of Li, Cu, Co, V, Cr, Ti, Mg, Sn, Zn, Al, Zr, Sr, Nb, B, Y, W, and La;
wherein the pre-sintering process comprises first temperature rise stage, second temperature rise stage and heat preservation stage, the conditions of the first temperature rise stage comprise: raising the temperature to T₁ at a temperature-rise rate v₁ in an oxygen-depleted atmosphere having an oxygen concentration less than or equal to 10 vol %; the conditions of the second temperature rise stage comprise: raising the temperature to T₂ at a temperature-rise rate v₂ in an oxygen-depleted atmosphere having an oxygen concentration less than or equal to 20 vol %; the conditions of the heat preservation stage comprise: preserving heat within the temperature range of (T₂−10)≤T≤(T₂+10) for a time t; wherein v₁ is selected from the range of 5-10° C./min, v₂ is selected from the range of 1-3° C./min, T₁ is selected from the range of 200-300° C., T₂ is selected from the range of 450-750° C.; t is selected from the range of 3-10 h.

The present application uses a specific pre-sintering process, and specifically defines the oxygen content, temperature-rise rate, temperature and time of the first temperature rise stage, the second temperature rise stage, and the heat preservation stage, increases the tap density of the precursor, can increases the production capacity, and can completely remove the water content contained in the precursor, solves the problems of different material phases of the precursor having various compositions, greatly facilitates the subsequent compounding and calcination process; in addition, the use of a specific pre-sintering process results in that the obtained pre-sintered precursor increases the porosity and the specific surface area while maintaining its morphology, enhances the reactivity, and is more conducive to the complete reaction with the sodium source during the subsequent compounding and calcination process, reduces the residual alkali on the cathode material surface, and improves the air stability.

Unless otherwise specified in the present application, “M and M′ in the cathode material are not simultaneously 0” means that in the preparation method for the cathode material, when the corner mark of M in the precursor having a composition represented by formula II is zero, the M′-containing dopant must be added; alternatively, when the M′-containing dopant is not added, the corner mark of M in the precursor having a composition represented by formula II is not zero; alternatively, when the corner mark of M in the precursor having a composition represented by formula II is not zero, the M′-containing dopant may be added or not.

In some embodiments of the present application, preferable, the average partice size D₅₀ of the precursor is within the range of 7.5-8.5 μm, and the particle size distribution satisfies the following condition: 1≤(D₉₀−D₁₀)/D₅₀≤1.5. When satisfying the above parameters, both the compaction density and the volumetric energy density of the cathode material are enhanced.

In some embodiments of the present application, preferably, the precursor has a tap density within the range of 0.7-1.5 g/cm³ and a specific surface area within the range of 30-100 m²/g.

In the present application, the primary particles of the precursor are uniformly and upright arranged in sheet form, and the surface is dense. When the precursor satisfies the above-mentioned ranges of the average particle size D₅₀, the particle size distribution, the tap density, and the specific surface area, the cathode material has the maximum compatibility of cycle stability and capacity.

The source of the precursor is selected from a wide range in the present application, as long as the precursor has the composition represented by the above formula II. Preferably, the precursor is produced with the following method: subjecting a mixed metal salt solution containing a Ni source, a Fe source, an Mn source and an M source, a precipitant solution, and a complexing agent solution to co-precipitation reaction in a non-oxidizing atmosphere to obtain the precursor.

In the present application, the non-oxidizing atmosphere includes but is not limited to, a nitrogen atmosphere, a helium atmosphere, an argon atmosphere, and the like, preferably a nitrogen atmosphere.

In some embodiments of the present application, the used amounts of a Ni source, a Fe source, a Mn source and a M source in the mixed metal salt solution satisfy the condition n(Ni):n(Fe):n(Mn):n(M), wherein 0≤n(Ni)≤0.5, 0≤n(Fe)≤0.5, 0≤n(Mn)≤0.5, 0≤n(M)≤0.5.

In some embodiments of the present application, the mixed metal salt solution has a concentration calculated in terms of the metal elements within the range of 1-5 mol/L, preferably within the range of 1-3 mol/L.

In a specific embodiment of the present application, the Ni source is at least one selected from the group consisting of nickel sulfate, nickel nitrate, and nickel chlorate; the Fe source is at least one selected from the group consisting of iron sulfate, iron nitrate, and iron chlorate; the Mn source is at least one selected from the group consisting of manganese sulfate, manganese nitrate, and manganese chlorate, the M source is at least one selected from the group consisting of sulfates, nitrates, and chlorates comprising M, i.e., at least one selected from the group consisting of sulfates, nitrates, and chlorates comprising Li, Cu, Co, V, Cr, Ti, Mg, Sn, Zn, Al, Zr, Sr, Nb, B, Y, W, and La; preferably at least one selected from the group consisting of sulfates, nitrates, and chlorates comprising Cu, Co, V, Cr, Ti, Mg, Sn, Zn, Al, Zr, Nb, Y, W, and La.

In some embodiments of the present application, the concentration of the precipitant solution is within the range of 3-10 mol/L. In the present application, precipitant in the precipitant solution is selected from the conventional choices in the art, including but not limited to NaOH, KOH, LiOH, etc.

In some embodiments of the present application, the concentration of the complexing agent is within the range of 2-11 mol/L. In the present application, complexing agent in the complexing agent solution is chosen from conventional choices in the art, including but not limited to ammonia water, ammonium bicarbonate, ammonium carbonate, citric acid, and disodium ethylenediaminetetraacetic acid.

According to some embodiments of the present application, preferably, the co-precipitation method adopted in the co-precipitation reaction is a batch process and particularly comprises feeding the mixed metal salt solution comprising a Ni source, a Fe source, an Mn source and an M source, a precipitant solution, and a complexing agent solution into a reaction kettle during a certain period by using a metering pump, and completing the sufficient crystallization and growth of the precipitant in the reaction kettle and discharging the precipitant. Carrying out the co-precipitation reaction in a batch process is advantageous for obtaining a precursor having a wider particle size distribution.

In some embodiments of the present application, preferably, the co-precipitation reaction conditions comprise a pH value of 10-12.5, a temperature of 40-80° C., a time of 48-120 h, and a stirring speed of 100-800 rpm.

In some embodiments of the present application, preferably, the precursor and the pre-sintered precursor each independently have a spherical structure.

In the present application, the co-precipitation reaction product is subjected to suction filtration, the obtained filter cake is subjected to drying at the temperature range of 100-140° C. and sieved to obtain the precursor.

In some embodiments of the present application, preferably, in step (1), the pre-sintered product is filtered, washed, and dried in sequence to obtain the pre-sintered precursor.

In some embodiments of the present application, preferably, in step (2), the used amounts of the pre-sintered precursor and the Na source satisfy the condition n(Ni+Fe+Mn+M):n(Na)=(0.8-1.1):1, for example, 0.8:1, 0.85:1, 0.93:1, 0.95:1, 1:1, 1.03:1, 1.05:1, 1.1:1, and a random value within the range consisting of any two numerical values thereof, preferably satisfy the condition n(Ni+Fe+Mn+M):n(Na)=(0.85-1.05):1, more preferably satisfy the condition n(Ni+Fe+Mn+M):n(Na)=(0.93-1.03):1.

In some embodiments of the present application, preferably, the Na source in step (2) is at least one selected from the group consisting of sodium carbonate, sodium hydroxide, sodium nitrate, and sodium oxide.

In some embodiments of the present application, preferably, the dopant is at least one selected from the group consisting of oxides, phosphates, carbonates, fluorides, chlorides, hydroxides, and silicides that contain the M′ element, i.e., at least one selected from the group consisting of sulfates, nitrates and chlorates containing Li, Cu, Co, V, Cr, Ti, Mg, Sn, Zn, Al, Zr, Sr, Nb, B, Y, W, La; more preferably at least one selected from the group consisting of sulfates, nitrates and chlorates containing Li, Al, Mg, Ti, Zr, Sr, La, Nb, B, W, further preferably at least one selected from the group consisting of Li₂CO₃, Al₂O₃, AlPO₄, AlCl₃, MgO, Mg₃(PO₄)₂, MgCO₃, MgSi₂, MgF₂, MgCl₂, TiO₂, ZrO, Zr(HPO₄)₂, ZrSi₂, Sr(OH)₂, SrCO₃, SrSi₂, SrF₂, SrCl₂, La₂O₃, Nb₂O₅, B₂O₃, and WO₃.

In some embodiments of the present application, preferably, in step (2), the calcination conditions comprise: a temperature selected from the range of 900-1,100° C.; and a time selected from the range of 5-15 h.

In some embodiments of the present application, further preferably, the calcination process comprises temperature rise stage I, temperature rise stage II, and constant temperature stage, the difference between the oxygen concentration in the atmosphere of the temperature rise stage II and the oxygen concentration in the atmosphere of the temperature rise stage I is within the range of 10-100 vol %, and the difference between the temperature-rise rate of the temperature rise stage I and the temperature rise rate of the temperature rise stage II is within the range of 2-15° C./min.

Unless otherwise specified in the present application, the expression “the difference between the oxygen concentration in the atmosphere of the temperature rise stage II and the oxygen concentration in the atmosphere of the temperature rise stage I is within the range of 10-100 vol %” means that the oxygen concentration in the atmosphere of the temperature rise stage II is higher than the oxygen concentration in the atmosphere of the temperature rise stage I, and the difference between the two oxygen concentrations is within the range of 10-100 vol. %; the expression “the difference between the temperature-rise rate of the temperature rise stage I and the temperature rise rate of the temperature rise stage II is within the range of 2-15° C./min” refers to that the temperature-rise rate of the temperature rise stage I is higher than the temperature-rise rate of the temperature rise stage II, and the difference between the two temperature-rise rate is within the range of 2-15° C./min.

In some embodiments of the present application, preferably, the conditions of the temperature rise stage I comprise: raising the temperature to T₁′ at a temperature-rise rate v₁′ in an oxygen-depleted atmosphere having an oxygen concentration less than or equal to 10 vol %; the conditions of the temperature rise stage II comprise: raising the temperature to T₂′ at a temperature-rise rate v₂′ in an atmosphere having an oxygen concentration larger than or equal to 20 vol %; the conditions of the constant temperature stage comprise: preserving heat within the temperature range of (T₂′−10)≤T′≤(T₂′+10) for a time t′; wherein v₁′≥3° C./min, v₂′≤1° C./min, T₁′ is selected from the range of 600-800° C., T₂′ is selected from the range of 900-1,100° C.; t′ is selected from the range of 5-15 h.

In some embodiments of the present application, preferably, in step (2), the method further comprises: sequentially cooling, crushing, and sieving the calcination product to obtain the cathode material.

In the present application, the cathode material prepared with the method provided by the present application has the composition represented by formula I: Naₐ(NiₓFe_{y}Mn_{z}MₘM′ₙ)O₂ (I), in formula I, 0.8≤a≤1.1, 0≤x≤0.5, 0≤y≤0.5, 0≤z≤0.5, 0≤m≤0.5, 0≤n≤0.2, 0.05≤m+n≤0.5, m and n are not simultaneously 0, x+y+z+m+n=1; M and M′ are each independently at least one element selected from the group consisting of Li, Cu, Co, V, Cr, Ti, Mg, Sn, Zn, Al, Zr, Sr, Nb, B, Y, W, and La;

further preferably, in formula I, 0.85≤a≤1.05, M is at least one element selected from the group consisting of Cu, Co, V, Cr, Ti, Mg, Sn, Zn, Al, Zr, Nb, Y, W, and La; and M′ is at least one element selected from the group consisting of Li, Al, Mg, Ti, Zr, Sr, La, Nb, B, and W;
more preferably, 0.93≤a≤1.03, M and M′ are different.

The third aspect of the present application provides a sodium ion battery containing the cathode material provided in the first aspect, or the cathode material produced with the method provided in the second aspect.

In the present application, the use of the cathode material in the sodium ion battery can effectively improve the electrochemical properties of the sodium ion battery, especially the rate capability, the cycle stability, and the volume energy density.

The present application has the following advantages over the prior art:
(1) the cathode material provided by the present application enhances the rate performance by defining that the cathode material has the characteristic diffraction peak A of (003) crystal plane and the characteristic diffraction peak B of (104) crystal plane and arranging the ratio D_{A}/D_{B} within a reasonable range, so that Na⁺ travels shorter distance during the charging and discharging process and can be transmitted in an easier manner; in addition, by defining a preferred range of the c value, the sodium layer spacing is guaranteed to be within a relatively small range, so that the normal intercalation/de-intercalation process of Na⁺ is not influenced, and the ingress of water and carbon dioxide in air into the interlayer and reaction with Na are avoided, i.e., the cathode material not only has a high sodium ion mobility with significantly improved air stability, but also has a gradation design of precursor with wide distribution of large particles and small particles, which causes that the prepared cathode material has a significantly improved compaction density and improved volume energy density of the material;
(2) the preparation method of the present application uses a specific pre-sintering process for the precursor having the composition represented by formula II (i.e., first temperature rise stage, second temperature rise stage, and heat preservation stage), improves the tap density of the precursor, can increase the production capacity, and may fully remove the water content contained in the precursor, solves the problem of different material phases of the precursor having various compositions, greatly facilitates the subsequent blending and calcination process; in addition, the treated pre-sintered precursor increases the porosity and specific surface area while maintaining its morphology, increases the reactivity, easily reacts fully with the sodium source during the subsequent compounding and calcination process, reduces the residual alkali on the cathode material surface, and improves the air stability.

The present application also regulates and controls the compaction density, volume energy density, and structural stability of the cathode material by adjusting the particle size distribution and composition of the precursor and the doped elements of the dopant, and mitigating volume changes caused by the Na+intercalation/de-intercalation process.

In summary, the preparation method provided by the present application causes the pre-sintered precursor to have a high density and a high reactivity, after the pre-sintered precursor is calcinated, the prepared cathode material exhibits a high air stability and desirable structural stability while maintaining a high volumetric energy density, and can overcome the problems of poor air stability and low cycle life of the existing layered oxide sodium ion battery cathode material.

The present application will be described in detail below with reference to examples.

(1) The composition of each of the precursor, the pre-sintering precursor and the cathode material was measured by adopting an Inductively Coupled Plasma (ICP) method; the used instrument was PE Optima 7000DV, the test conditions were as follow: 0.1 g of sample was completely dissolved in a mixed acid solution composed of 3 mL of HNO₃ and 9 mL of HCl, and the solution was diluted to 250 mL for testing.

(2) The morphology of the material was observed by using a Scanning Electron Microscope (SEM), wherein the instrument was the SEM with a model S-4800 manufactured by the Hitachi Corporation of Japan.

(3) The particle sizes of the precursor and the cathode material were measured by using the Malvern particle size analyzer.

(4) The crystal structure of the cathode material was tested with the X-Ray Diffraction (XRD); the instrument was an X-ray diffractometer (manufactured by Rigaku Corporation in Japan, Smart Lab 9 KW), and the test conditions were as follow: the X-ray source was the Cu-Kα ray, the scanning range was 10°-80°, the scanning speed was 1.2°/min, and the sampling width was 0.02°.

(5) The compaction density of a cathode material was measured by a powder compaction method; the instrument in use was a powder compaction instrument (MCP-PD51) with the test condition of 20 KN.

(6) The tap density of the precursor was measured by a fixed mass method; the specific surface area of the precursor was measured by adopting a BET specific surface area test method.

(7) The microcrystalline size ratio D_{A}/D_{B} was determined by using the following method: a cathode material was filled into a dedicated substrate, and the half-spectrum measurement was performed using the Cu Kα ray source under conditions consisting of two diffraction angle ranges 2θ_{A}=15-19° and 2θ_{B}=39-44°, a sampling width of 0.02°, and a scanning speed of 1.2°/min, thereby obtaining the powder X-ray diffraction patterns of peak A and peak B, respectively; the comprehensive analysis software JADE 6.5 for powder X-ray diffraction patterns was used, the powder X-ray diffraction patterns were measured and obtained from the powder X-ray diffraction, and the half-peak widths of the characteristic diffraction peak A appeared at the range of 2θ=16.5±1° and the characteristic diffraction peak B appeared at the range of 2θ=41.5±1° were obtained respectively; the obtained half-peak widths were used for calculating the microcrystalline size D_{A} and the microcrystalline size D_{B} respectively according to the Scherrer formula, such that a microcrystalline size ratio was obtained.

(8) Electrochemical properties test: in the following Examples and Comparative Examples, electrochemical properties of the cathode materials were tested using the button-type sodium ion battery with the model R2025.

The preparation process of the sodium ion battery was as follows:

Preparing a cathode pole: sodium ion battery cathode material, conductive agent SuperP, and polyvinylidene fluoride (PVDF) were mixed according to a mass ratio of 90:5:5 and sufficiently blended with a suitable amount of N-methylpyrrolidone (NMP) to form a uniform slurry, the slurry was coated on an aluminum foil and dried at 120° C. for 12 h, the coated aluminum foil was then subjected to punch forming under the pressure of 100 MPa to prepare the cathode pole with a diameter of 12 mm and a thickness of 120 μm.

Assembling the battery: a cathode pole, a diaphragm, an anode pole, and an electrolyte were assembled in an argon gas-filled glove box with water content and oxygen content less than 5 ppm, to assemble the button type sodium ion battery with the model R2025, the sodium ion battery was subjected to standing still for 6 h. Wherein the anode pole was a metal sodium piece with a diameter of 14 mm and a thickness of 1 mm; the diaphragm was a gummed diaphragm with a thickness of 25 μm; the electrolyte was a mixed solution of NaPF₆ with a concentration of 1 mol/L, Ethyl Methyl Carbonate (EMC) and Propylene Carbonate (PC) at a ratio of 4:6.

### TESTING OF THE ELECTROCHEMICAL PROPERTIES

In the following Examples and Comparative Examples, the testing of electrochemical properties was performed on the button-type sodium-ion battery with the model R2025 by using the Shenzhen Neware Battery Test System (CT 3008), the testing conditions of the first charge and discharge capacity were as follow: 0.1 C@2-4.0V, 25° C., and a constant voltage cutoff current was 0.02 C; the testing conditions of the cycle stability were as follow: 1.0 C@2-4.0V, 25° C. The button-type sodium-ion battery was subjected to the constant current charge and discharge test at the current of 0.1 C and 1 C, the charge-discharge specific capacity, the cycle stability, and the volume energy density of the sodium ion battery cathode material were evaluated; wherein the higher was the capacity retention rate in the cycle process, it indicated that the material stability was the higher, and the cycle stability of a battery system was the better.

### Example 1

S1: nickel sulfate, ferric sulfate, manganese sulfate, and copper sulfate were dissolved according to the molar ratio of nickel, iron, manganese, and copper elements being 20:30:40:10 to obtain a mixed metal salt solution having a concentration of 2 mol/L; sodium hydroxide was dissolved into a precipitator solution with the concentration of 8 mol/L; ammonia water was dissolved into a complexing agent solution with the concentration of 10.4 mol/L;
100 L of the mixed metal salt solution, the precipitator solution, and the complexing agent solution were introduced into a reaction kettle in a concurrent flow mode to carry out co-precipitation reaction, the precipitate was then continuously controlled to grow in an overflow device under the protection of argon gas atmosphere until an average partice size of the particles grew to 8 μm; the precursor slurry was subjected to the suction filtration and washing, the filter cake was dried at 120° C. and then sieved to obtain the precursor (both the composition and the physical property parameters of the precursor were listed in Table 1);
wherein the co-precipitation reaction conditions comprised a temperature of 60° C. and a pH of 12.38;
S2: the precursor was pre-sintered, and the obtained pre-sintered product was naturally cooled to obtain a pre-sintered precursor (the composition was shown in Table 1);
the conditions of the first temperature rise stage comprised: the temperature was raised from 25° C. to T₁=250° C. at a temperature-rise rate v₁=6° C./min in an oxygen-depleted atmosphere having an oxygen concentration of 10 vol %;
the conditions of the second temperature rise stage comprised: the temperature was raised from 250° C. to T₂=550° C. at a temperature-rise rate v₂=2° C./min in an atmosphere having an oxygen concentration of 20 vol %;
the conditions of the heat preservation stage comprised: the heat preservation was performed within the temperature range of T=540-560° C. for a time t=4 h;
S3: the pre-sintered precursor and Na₂CO₃ were subjected to calcinating, cooling, crushing, and sieving to obtain O3-type monocrystal cathode material S1 (the composition, crystal form, and physical property parameters were listed in Table 1);
the used amounts of the pre-sintered precursor and the Na source satisfied n(Ni+Fe+Mn+Cu):n(Na)=1:0.96;
the conditions of the temperature rise stage I comprised: the temperature was raised from 25° C. to T₁′=700° C. at a temperature-rise rate v₁′=3° C./min in an oxygen-depleted atmosphere having an oxygen concentration of 10 vol %;
the conditions of the temperature rise stage II comprised: the temperature was raised from 700° C. to T₂′=950° C. at a temperature-rise rate v₂′=1° C./min in an atmosphere having an oxygen concentration of 20 vol %;
the conditions of the constant temperature stage comprised: the heat preservation was performed at the temperature T′=950° C. for a time t′=15 h.

### Example 2

The cathode material was prepared according to the same method as that in Example 1, except that
in step S2, the temperature T₂=450° C. in the second temperature rise stage; the temperature T=440-460° C. in the heat preservation stage;
the remaining conditions were identical, such that the O3-type monocrystal cathode material S2 was obtained.

### Example 3

The cathode material was prepared according to the same method as that in Example 1, except that
in step S3, the pre-sintered precursor, Na₂CO₃ and Al₂O₃ were subjected to calcinating, cooling, crushing, and sieving to obtain O3-type monocrystal cathode material S3 (the composition, crystal form, and physical property parameters were listed in Table 1);
the used amount of the Al₂O₃ satisfied n(Al):n(Ni+Fe+Mn+Cu+Al)=0.05.
the remaining conditions were identical, such that the O3-type monocrystal cathode material S3 was obtained.

### Example 4

The cathode material was prepared according to the same method as that in Example 1, except that
in step S2, the time t=10 h in the heat preservation stage;
the remaining conditions were identical, such that the O3-type monocrystal cathode material S4 was obtained.

### Example 5

The cathode material was prepared according to the same method as that in Example 1, except that
in step S2, the temperature-rise rate v₁=10° C./min in the first temperature rise stage, and the temperature-rise rate v₂=1° C./min in the second temperature rise stage;
the remaining conditions were identical, such that the O3-type monocrystal cathode material S5 was obtained.

### Example 6

The cathode material was prepared according to the same method as that in Example 1, except that
in step S1, the crystal growth of the precipitate was regulated and controlled such that the partice size distribution of the precursor satisfied the following condition:

$${K}_{90} = ( {D}_{90} - {D}_{10} ) / {D}_{50} = 1 ;$$

the remaining conditions were identical, such that the O3-type monocrystal cathode material S6 was obtained.

### Example 7

The cathode material was prepared according to the same method as that in Example 1, except that
in step S1, nickel sulfate, ferric sulfate, manganese sulfate, and copper sulfate were dissolved according to the molar ratio of nickel, iron, manganese, and copper elements being 22:25:42:11 to obtain a mixed metal salt solution having a concentration of 2 mol/L;
the remaining conditions were identical, such that the O3-type monocrystal cathode material S7 was obtained.

### Example 8

The cathode material was prepared according to the same method as that in Example 1, except that
in step S1, the crystal growth of the precipitate was regulated and controlled such that the partice size distribution of the precursor satisfied the following condition:

$${K}_{90} = ( {D}_{90} - {D}_{10} ) / {D}_{50} = 0.8 ;$$

the remaining conditions were identical, such that the O3-type monocrystal cathode material S8 was obtained.

### Example 9

The cathode material was prepared according to the same method as that in Example 1, except that
in step S1, nickel sulfate, ferric sulfate, manganese sulfate, and zinc sulfate were dissolved according to the molar ratio of nickel, iron, manganese, and zinc elements being 20:30:40:10 to obtain a mixed metal salt solution having a concentration of 2 mol/L;
the remaining conditions were identical, such that the O3-type monocrystal cathode material S9 was obtained.

### Example 10

The cathode material was prepared according to the same method as that in Example 1, except that
in step S1, nickel sulfate, ferric sulfate, manganese sulfate, and stannous sulfate were dissolved according to the molar ratio of nickel, iron, manganese, and tin elements being 20:30:40:10 to obtain a mixed metal salt solution having a concentration of 2 mol/L;
the remaining conditions were identical, such that the O3-type monocrystal cathode material S10 was obtained.

### Example 11

The cathode material was prepared according to the same method as that in Example 1, except that
in step S3, the pre-sintered precursor, Na2CO3 and ZrO2 were subjected to calcinating, cooling, crushing, and sieving to obtain O3-type monocrystal cathode material S11 (the composition, crystal form, and physical property parameters were listed in Table 1);
the used amount of the ZrO2 satisfied n(Zr):n(Ni+Fe+Mn+Cu+Zr)=0.05.
the remaining conditions were identical, such that the O3-type monocrystal cathode material S11 was obtained.

### Example 12

The cathode material was prepared according to the same method as that in Example 1, except that
in step S3, the pre-sintered precursor, Na2CO3 and Sr(OH)2 were subjected to calcinating, cooling, crushing, and sieving to obtain O3-type monocrystal cathode material S12 (the composition, crystal form, and physical property parameters were listed in Table 1);
the used amount of the Sr(OH)2 satisfied n(Sr):n(Ni+Fe+Mn+Cu+Sr)=0.05.
the remaining conditions were identical, such that the O3-type monocrystal cathode material S12 was obtained.

### Example 13

The cathode material was prepared according to the same method as that in Example 1, except that
in step S3, the pre-sintered precursor, Na2CO3 and La2O3 were subjected to calcinating, cooling, crushing, and sieving to obtain O3-type monocrystal cathode material S13 (the composition, crystal form, and physical property parameters were listed in Table 1);
the used amount of the La2O3 satisfied n(La):n(Ni+Fe+Mn+Cu+La)=0.05.
the remaining conditions were identical, such that the O3-type monocrystal cathode material S13 was obtained.

### Example 14

The cathode material was prepared according to the same method as that in Example 1, except that
in step S3, the pre-sintered precursor, Na2CO3 and WO3 were subjected to calcinating, cooling, crushing, and sieving to obtain O3-type monocrystal cathode material S11 (the composition, crystal form, and physical property parameters were listed in Table 1);
the used amount of the WO3 satisfied n(W):n(Ni+Fe+Mn+Cu+W)=0.05.
the remaining conditions were identical, such that the O3-type monocrystal cathode material S14 was obtained.

### Comparative Example 1

The cathode material was prepared according to the same method as that in Example 1, except that the step S2 was not performed,
that is, the precursor obtained in step S1 was directly subjected to the calcination treatment in step S3,
the remaining conditions were identical, such that the O3-type monocrystal cathode material DS1 was obtained.

### Comparative Example 2

The cathode material was prepared according to the same method as that in Example 1, except that
in step S2, the temperature T₂=300° C. in the second temperature rise stage; the temperature T=290-310° C. in the heat preservation stage;
the remaining conditions were identical, such that the O3-type monocrystal cathode material DS2 was obtained.

### Comparative Example 3

The cathode material was prepared according to the same method as that in Example 1, except that
in step S2, the temperature T₂=1,000° C. in the second temperature rise stage; the temperature T=990-1,010° C. in the heat preservation stage;
the remaining conditions were identical, such that the O3-type monocrystal cathode material DS3 was obtained.

### Comparative Example 4

The cathode material was prepared according to the same method as that in Example 1, except that
in step S2, the time t=1 h in the heat preservation stage;
the remaining conditions were identical, such that the O3-type monocrystal cathode material DS4 was obtained.

### Comparative Example 5

The cathode material was prepared according to the same method as that in Example 1, except that
in step S2, the temperature-rise rate v₂=10° C./min in the second temperature-rise stage;
the remaining conditions were identical, such that the O3-type monocrystal cathode material DS5 was obtained.

### Comparative Example 6

The cathode material was prepared according to the same method as that in Example 1, except that
in step S2, there was not the first temperature rise stage, i.e., the precursor was directly heated from the temperature of 25° C. to T₂=550° C. at a temperature-rise rate v₂=2° C./min in an atmosphere with an oxygen concentration of 20 vol %, and the heat preservation was then performed at the temperature range T=540-560° C. for a time t=4 h;
the remaining conditions were identical, such that the O3-type monocrystal cathode material DS6 was obtained.

TABLE 1

| | Precursor | | | |
|---|---|---|---|---|
| | | Average | | |
| | | particle size | | Tap density, |
| | Composition | D₅₀, μm | K₉₀ | g/cm³ |
| Example 1 | ¼(Ni_{0.2}Fe_{0.3}Mn_{0.4}Cu_{0.1})OOH@ | 8 | 1.5 | 1.3 |
| Example 2 | ¾(Ni_{0.2}Fe_{0.3}Mn_{0.4}Cu_{0.1})O_{4/3} | | | |
| Example 3 | compound phase | | | |
| Example 4 | | | | |
| Example 5 | | | | |
| Example 6 | | 8 | 1 | 1.0 |
| Example 7 | ¼(Ni_{0.22}Fe_{0.25}Mn_{0.42}Cu_{0.11})OOH@ | 8 | 1.5 | 1.3 |
| | ¾(Ni_{0.22}Fe_{0.25}Mn_{0.42}Cu_{0.11})O_{4/3} | | | |
| | compound phase | | | |
| Example 8 | ¼(Ni_{0.2}Fe_{0.3}Mn_{0.4}Cu_{0.1})OOH@ | 8 | 0.8 | 0.8 |
| | ¾(Ni_{0.2}Fe_{0.3}Mn_{0.4}Cu_{0.1})O_{4/3} | | | |
| | compound phase | | | |
| Example 9 | ¼(Ni_{0.2}Fe_{0.3}Mn_{0.4}Zn_{0.1})OOH@ | 8 | 1.5 | 1.3 |
| | ¾(Ni_{0.2}Fe_{0.3}Mn_{0.4}Zn_{0.1})O_{4/3} | | | |
| | compound phase | | | |
| Example 10 | ¼(Ni_{0.2}Fe_{0.3}Mn_{0.4}Sn_{0.1})OOH@ | 8 | 1.5 | 1.3 |
| | ¾(Ni_{0.2}Fe_{0.3}Mn_{0.4}Sn_{0.1})O_{4/3} | | | |
| | compound phase | | | |
| Example 11 | ¼(Ni_{0.2}Fe_{0.3}Mn_{0.4}Cu_{0.1})OOH@ | 8 | 1.5 | 1.3 |
| Example 12 | ¾(Ni_{0.2}Fe_{0.3}Mn_{0.4}Cu_{0.1})O_{4/3} | | | |
| Example 13 | compound phase | | | |
| Example 14 | | | | |
| Comparative | | | | |
| Example 1 | | | | |
| Comparative | | | | |
| Example 2 | | | | |
| Comparative | | | | |
| Example 3 | | | | |
| Comparative | | | | |
| Example 4 | | | | |
| Comparative | | | | |
| Example 5 | | | | |
| Comparative | | | | |
| Example 6 | | | | |

| | Pre-sintering | | | | | |
|---|---|---|---|---|---|---|
| | v₁, ° C./min | T₁, ° C. | v₂, ° C./min | T₂, ° C. | T, ° C. | t, h |
| Example 1 | 6 | 250 | 2 | 550 | 540-560 | 4 |
| Example 2 | 6 | 250 | 2 | 450 | 440-450 | 4 |
| Example 3 | 6 | 250 | 2 | 550 | 540-560 | 4 |
| Example 4 | 6 | 250 | 2 | 550 | 540-560 | 10 |
| Example 5 | 10 | 250 | 1 | 550 | 540-560 | 4 |
| Example 6 | 6 | 250 | 2 | 550 | 540-560 | 4 |
| Example 7 | 6 | 250 | 2 | 550 | 540-560 | 4 |
| Example 8 | 6 | 250 | 2 | 550 | 540-560 | 4 |
| Example 9 | 6 | 250 | 2 | 450 | 440-450 | 4 |
| Example 10 | 6 | 250 | 2 | 550 | 540-560 | 4 |
| Example 11 | 6 | 250 | 2 | 550 | 540-560 | 4 |
| Example 12 | 6 | 250 | 2 | 550 | 540-560 | 4 |
| Example 13 | 6 | 250 | 2 | 550 | 540-560 | 4 |
| Example 14 | 6 | 250 | 2 | 550 | 540-560 | 4 |
| Comparative | — | — | — | — | — | — |
| Example 1 | | | | | | |
| Comparative | 6 | 250 | 2 | 300 | 290-310 | 4 |
| Example 2 | | | | | | |
| Comparative | 6 | 250 | 2 | 1000 | 990-1010 | 4 |
| Example 3 | | | | | | |
| Comparative | 6 | 250 | 2 | 550 | 540-560 | 1 |
| Example 4 | | | | | | |
| Comparative | 6 | 250 | 10 | 550 | 540-560 | 4 |
| Example 5 | | | | | | |
| Comparative | — | — | 2 | 550 | 540-560 | 4 |
| Example 6 | | | | | | |

| | Pre-sintered precursor | n(Na)¹ | n(Dopant)² |
|---|---|---|---|
| Example 1 | (Ni_{0.2}Fe_{0.3}Mn_{0.4}Cu_{0.1})₃O₄ | 0.96 | — |
| Example 2 | (Ni_{0.2}Fe_{0.3}Mn_{0.4}Cu_{0.1})₃O₄ | 0.96 | — |
| Example 3 | (Ni_{0.2}Fe_{0.3}Mn_{0.4}Cu_{0.1})₃O₄ | 0.96 | 0.05 |
| Example 4 | (Ni_{0.2}Fe_{0.3}Mn_{0.4}Cu_{0.1})₃O₄ | 0.96 | — |
| Example 5 | (Ni_{0.2}Fe_{0.3}Mn_{0.4}Cu_{0.1})₃O₄ | 0.96 | — |
| Example 6 | (Ni_{0.2}Fe_{0.3}Mn_{0.4}Cu_{0.1})₃O₄ | 0.96 | — |
| Example 7 | (Ni_{0.22}Fe_{0.25}Mn_{0.42}Cu_{0.11})₃O₄ | 0.96 | — |
| Example 8 | (Ni_{0.2}Fe_{0.3}Mn_{0.4}Cu_{0.1})₃O₄ | 0.96 | — |
| Example 9 | (Ni_{0.2}Fe_{0.3}Mn_{0.4}Zn_{0.1})₃O₄ | 0.96 | — |
| Example 10 | (Ni_{0.2}Fe_{0.3}Mn_{0.4}Sn_{0.1})₃O₄ | 0.96 | 0.05 |
| Example 11 | (Ni_{0.2}Fe_{0.3}Mn_{0.4}Cu_{0.1})₃O₄ | 0.96 | 0.05 |
| Example 12 | (Ni_{0.2}Fe_{0.3}Mn_{0.4}Cu_{0.1})₃O₄ | 0.96 | 0.05 |
| Example 13 | (Ni_{0.2}Fe_{0.3}Mn_{0.4}Cu_{0.1})₃O₄ | 0.96 | 0.05 |
| Example 14 | (Ni_{0.2}Fe_{0.3}Mn_{0.4}Cu_{0.1})₃O₄ | 0.96 | 0.05 |
| Comparative | — | 0.96 | — |
| Example 1 | | | |
| Comparative | ⅕(Ni_{0.2}Fe_{0.3}Mn_{0.4}Cu_{0.1})OOH@ | 0.96 | — |
| Example 2 | ⅘(Ni_{0.2}Fe_{0.3}Mn_{0.4}Cu_{0.1})O_{4/3} | | |
| | compound phase | | |
| Comparative | (Ni_{0.2}Fe_{0.3}Mn_{0.4}Cu_{0.1})₃O₄ | 0.96 | — |
| Example 3 | | | |
| Comparative | ⅙(Ni_{0.2}Fe_{0.3}Mn_{0.4}Cu_{0.1})OOH@ | 0.96 | — |
| Example 4 | ⅚(Ni_{0.2}Fe_{0.3}Mn_{0.4}Cu_{0.1})O_{4/3} | | |
| | compound phase | | |
| Comparative | (Ni_{0.2}Fe_{0.3}Mn_{0.4}Cu_{0.1})₃O₄ | 0.96 | — |
| Example 5 | | | |
| Comparative | (Ni_{0.2}Fe_{0.3}Mn_{0.4}Cu_{0.1})₃O₄ | 0.96 | — |
| Example 6 | | | |

| | Cathode material | | |
|---|---|---|---|
| | Composition | D_{A}/D_{B} | C, Å |
| Example 1 | O3-Na_{0.96}Ni_{0.2}Fe_{0.3}Mn_{0.4}Cu_{0.1}O₂ | 1.37 | 16.0641 |
| Example 2 | O3-Na_{0.96}Ni_{0.2}Fe_{0.3}Mn_{0.4}Cu_{0.1}O₂ | 1.58 | 16.0524 |
| Example 3 | O3-Na_{0.96}[(Ni_{0.2}Fe_{0.3}Mn_{0.4}Cu_{0.1})_{0.95}Al_{0.05}]O₂ | 1.53 | 16.0731 |
| Example 4 | O3-Na_{0.96}Ni_{0.2}Fe_{0.3}Mn_{0.4}Cu_{0.1}O₂ | 1.77 | 16.0525 |
| Example 5 | O3-Na_{0.96}Ni_{0.2}Fe_{0.3}Mn_{0.4}Cu_{0.1}O₂ | 1.62 | 16.0413 |
| Example 6 | O3-Na_{0.96}Ni_{0.2}Fe_{0.3}Mn_{0.4}Cu_{0.1}O₂ | 1.31 | 16.0417 |
| Example 7 | O3-Na_{0.96}Ni_{0.22}Fe_{0.25}Mn_{0.42}Cu_{0.11}O₂ | 1.58 | 16.0617 |
| Example 8 | O3-Na_{0.96}Ni_{0.2}Fe_{0.3}Mn_{0.4}Cu_{0.1}O₂ | 1.49 | 16.0626 |
| Example 9 | O3-Na_{0.96}Ni_{0.2}Fe_{0.3}Mn_{0.4}Zn_{0.1}O₂ | 1.40 | 16.0742 |
| Example 10 | O3-Na_{0.96}Ni_{0.2}Fe_{0.3}Mn_{0.4}Sn_{0.1}O₂ | 1.42 | 16.0687 |
| Example 11 | O3-Na_{0.96}[(Ni_{0.2}Fe_{0.3}Mn_{0.4}Cu_{0.1})_{0.95}Zr_{0.05}]O₂ | 1.59 | 16.0727 |
| Example 12 | O3-Na_{0.96}[(Ni_{0.2}Fe_{0.3}Mn_{0.4}Cu_{0.1})_{0.95}Sr_{0.05}]O₂ | 1.61 | 16.0431 |
| Example 13 | O3-Na_{0.96}[(Ni_{0.2}Fe_{0.3}Mn_{0.4}Cu_{0.1})_{0.95}La_{0.05}]O₂ | 1.63 | 16.0391 |
| Example 14 | O3-Na_{0.96}[(Ni_{0.2}Fe_{0.3}Mn_{0.4}Cu_{0.1})_{0.95}W_{0.05}]O₂ | 1.62 | 16.0378 |
| Comparative | O3-Na_{0.96}Ni_{0.2}Fe_{0.3}Mn_{0.4}Cu_{0.1}O₂ | 1.11 | 16.1311 |
| Example 1 | | | |
| Comparative | O3-Na_{0.96}Ni_{0.2}Fe_{0.3}Mn_{0.4}Cu_{0.1}O₂ | 0.96 | 16.1141 |
| Example 2 | | | |
| Comparative | O3-Na_{0.96}Ni_{0.2}Fe_{0.3}Mn_{0.4}Cu_{0.1}O₂ | 1.05 | 16.1271 |
| Example 3 | | | |
| Comparative | O3-Na_{0.96}Ni_{0.2}Fe_{0.3}Mn_{0.4}Cu_{0.1}O₂ | 1.05 | 16.1132 |
| Example 4 | | | |
| Comparative | O3-Na_{0.96}Ni_{0.2}Fe_{0.3}Mn_{0.4}Cu_{0.1}O₂ | 1.12 | 16.1153 |
| Example 5 | | | |
| Comparative | O3-Na_{0.96}Ni_{0.2}Fe_{0.3}Mn_{0.4}Cu_{0.1}O₂ | 1.21 | 16.1251 |
| Example 6 | | | |

| | Cathode material | | | | |
|---|---|---|---|---|---|
| | | | | Compaction | |
| | D_{A}, nm | D_{B}, nm | D₅₀, μm | density, g/cm³ | K₉₀ |
| Example 1 | 57.8 | 42.4 | 8.0 | 3.55 | 1.4 |
| Example 2 | 59.4 | 37.6 | 8.0 | 3.42 | 1.4 |
| Example 3 | 58.3 | 38.1 | 8.0 | 3.39 | 1.4 |
| Example 4 | 60.2 | 34.0 | 8.0 | 3.40 | 1.4 |
| Example 5 | 59.7 | 36.9 | 8.0 | 3.38 | 1.4 |
| Example 6 | 57.2 | 43.7 | 8.0 | 3.24 | 1.1 |
| Example 7 | 59.4 | 37.6 | 8.0 | 3.54 | 1.4 |
| Example 8 | 58.1 | 39.0 | 8.0 | 3.18 | 0.9 |
| Example 9 | 57.6 | 41.2 | 8.0 | 3.53 | 1.4 |
| Example 10 | 58.1 | 40.9 | 8.0 | 3.51 | 1.4 |
| Example 11 | 58.4 | 36.8 | 8.0 | 3.44 | 1.4 |
| Example 12 | 59.9 | 37.2 | 8.0 | 3.45 | 1.4 |
| Example 13 | 60.1 | 36.9 | 8.0 | 3.40 | 1.4 |
| Example 14 | 59.4 | 36.7 | 8.0 | 3.43 | 1.4 |
| Comparative | 55.3 | 49.8 | 8.0 | 3.23 | 1.4 |
| Example 1 | | | | | |
| Comparative | 56.1 | 58.4 | 8.0 | 3.21 | 1.4 |
| Example 2 | | | | | |
| Comparative | 55.5 | 52.9 | 8.0 | 3.21 | 1.4 |
| Example 3 | | | | | |
| Comparative | 55.5 | 52.9 | 8.0 | 3.20 | 1.4 |
| Example 4 | | | | | |
| Comparative | 55.4 | 49.5 | 8.0 | 3.21 | 1.4 |
| Example 5 | | | | | |
| Comparative | 54.5 | 45.0 | 8.0 | 3.27 | 1.4 |
| Example 6 | | | | | |

Note:
K₉₀ = (D₉₀ − D₁₀)/D₅₀.
Note:
¹means that the used amounts of the Na source and the pre-sintered precursor satisfy n(Na): n(Ni + Fe + Mn + Cu);
²means that the used amounts of the dopant satisfies n(M′): n(Ni + Fe + Mn + M + M′).

As can be seen from the results of Table 1, in comparison with Comparative Examples 1-6, the cathode materials in Examples 1-8 produced with the method provided by the present application satisfy the following conditions: 1.3≤D_{A}/D_{B}≤2.5, particularly 1.3≤D_{A}/D_{B}≤2, and the c value is selected from the range of 16-16.1 Å.

In comparison to Example 8, Examples 1-7 regulate and control the particle size distribution of the precursors to satisfy the following condition: 1≤(D₉₀−D₁₀)/D₅₀≤1.5, thereby more effectively increasing the compaction density of the cathode materials, and the volumetric energy density of the electrodes made from the cathode materials.

### TEST EXAMPLES

### (1) Morphology Test

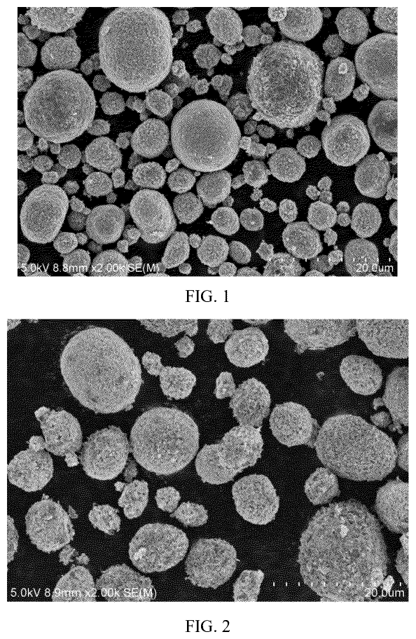

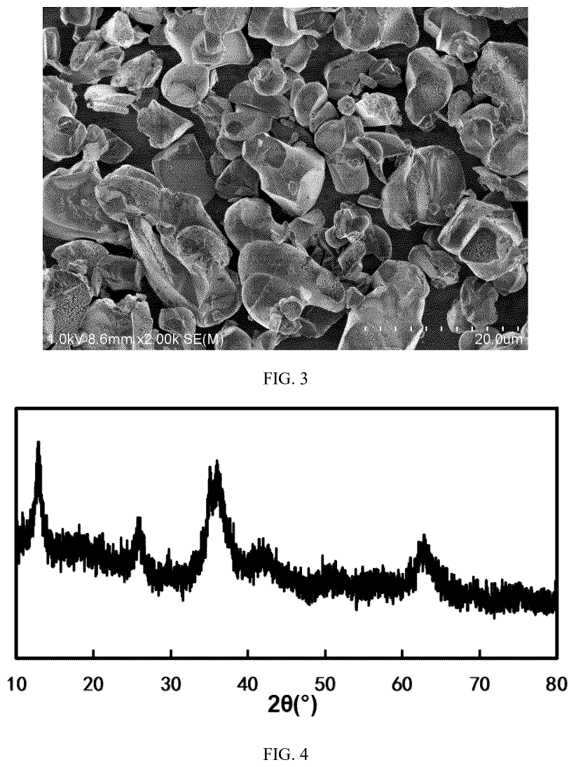

The present application tested the scanning electron microscope images of the precursors, the pre-sintered precursors, and the O3-type monocrystal cathode materials prepared in the above Examples and Comparative Examples, and exemplarily provided the SEM images of the precursor, the pre-sintered precursor and the O3-type monocrystal cathode material S1 prepared in Example 1, the results were as shown in FIGS. 1-3, respectively, as can be seen from FIG. 1, the particle size distribution of the precursor particles was wide, and the surface of the large and small particles was dense; as illustrated by FIG. 2, the pre-sintered precursor still maintained the spherical shape and the wide distribution of the precursor, and its surface was more rounded and dense; as shown by FIG. 3, the surface of the large and small monocrystal particles of the O3-type monocrystal cathode material S1 was smooth and rounded, and the particle size distribution was wider, the small particles were filled between the large particles, and exhibited the desirable gradation performance.

### (2) Test of Physical Properties

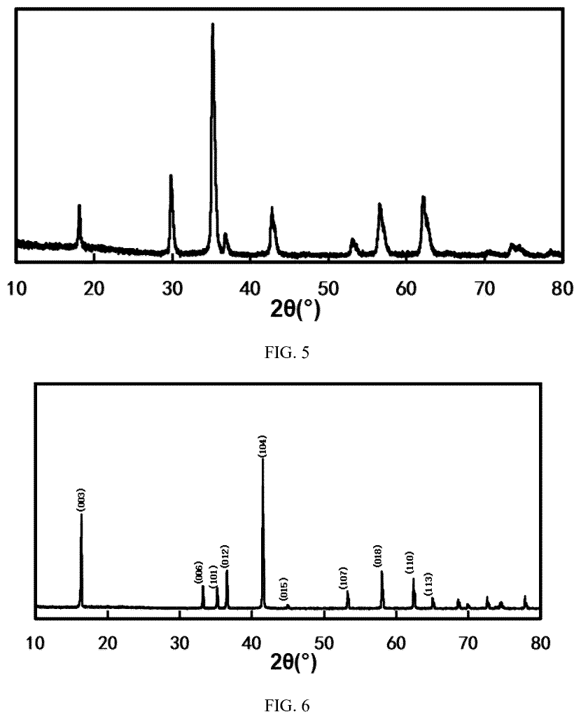

The present application tested the X-Ray Diffraction (XRD) of the precursors, the pre-sintered precursors, and the O3-type monocrystal cathode material S1 in the Examples and Comparative Examples described above, and exemplarily provided the XRD images of the precursor, the pre-sintered precursor and the O3-type monocrystal cathode material S1 prepared in Example 1, the results were as shown in FIGS. 4-6, respectively. As illustrated by FIG. 4, the material phase of the precursor was ¼(Ni_{0.2}Fe_{0.3}Mn_{0.4}Cu_{0.1})OOH@¾(Ni_{0.2}Fe_{0.3}Mn_{0.4}Cu_{0.1})O_{4/3} compound phase; as shown from FIG. 5, the material phase of the pre-sintered precursor was (Ni_{0.2}Fe_{0.3}Mn_{0.4}Cu_{0.1})₃O₄ pure phase; as can be seen from FIG. 6, the material phase of the monocrystal cathode material S1 was sodium electron O3-type layered oxide (Na_{0.96}Ni_{0.2}Fe_{0.3}Mn_{0.4}Cu_{0.1}O₂).

The O3-type monocrystal cathode material samples prepared and obtained in the above-mentioned Examples and Comparative Examples were simultaneously exposed to air having a relative humidity of 45% for 0-6 h, the exact moisture, residual alkali, and XRD characteristic diffraction peak parameters were as shown in Table 2.

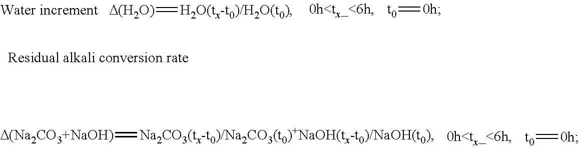

TABLE 2

| | Example 1 | | | Example 2 | | |
|---|---|---|---|---|---|---|
| Time (h) | 0 | 1 | 6 | 0 | 1 | 6 |
| H₂O (ppm) | 306 | 351 | 561 | 317 | 357 | 589 |
| ΔH₂O (%) | 0.0 | 14.7 | 83.3 | 0.0 | 12.6 | 85.8 |
| Na₂CO₃ (wt %) | 0.51 | 0.82 | 1.17 | 0.64 | 0.93 | 1.21 |
| NaOH (wt %) | 1.01 | 0.93 | 1.15 | 1.06 | 1.05 | 1.35 |
| Δ(Na₂CO₃ + NaOH) (%) | 0.0 | 52.9 | 143.3 | 0.0 | 44.4 | 116.4 |
| 2θ₍₀₀₃₎ | 16.523 | 16.521 | 16.518 | 16.522 | 16.519 | 16.511 |
| | Example 3 | | | Example 4 | | |
| Time (h) | 0 | 1 | 6 | 0 | 1 | 6 |
| H₂O (ppm) | 308 | 353 | 577 | 299 | 353 | 566 |
| ΔH₂O (%) | 0.0 | 14.6 | 87.3 | 0.0 | 18.1 | 89.3 |
| Na₂CO₃ (wt %) | 0.61 | 0.89 | 1.20 | 0.57 | 0.94 | 1.17 |
| NaOH (wt %) | 1.02 | 0.99 | 1.17 | 1.08 | 1.01 | 1.28 |
| Δ(Na₂CO₃ + NaOH) (%) | 0.0 | 43.0 | 111.4 | 0.0 | 58.4 | 123.8 |
| 2θ₍₀₀₃₎ | 16.522 | 16.520 | 16.517 | 16.523 | 16.520 | 16.517 |
| | Example 5 | | | Example 6 | | |
| Time (h) | 0 | 1 | 6 | 0 | 1 | 6 |
| H₂O (ppm) | 301 | 376 | 593 | 301 | 347 | 566 |
| ΔH₂O (%) | 0.0 | 24.9 | 97.0 | 0.0 | 15.3 | 88.0 |
| Na₂CO₃ (wt %) | 0.79 | 0.98 | 1.51 | 0.54 | 0.88 | 1.16 |
| NaOH (wt %) | 1.07 | 1.05 | 1.35 | 1.08 | 0.91 | 1.21 |
| Δ(Na₂CO₃ + NaOH) (%) | 0.0 | 22.2 | 117.3 | 0.0 | 47.2 | 126.9 |
| 2θ₍₀₀₃₎ | 16.522 | 16.521 | 16.516 | 16.520 | 16.518 | 16.515 |
| | Example 7 | | | Example 8 | | |
| Time (h) | 0 | 1 | 6 | 0 | 1 | 6 |
| H₂O (ppm) | 301 | 355 | 542 | 302 | 351 | 561 |
| ΔH₂O (%) | 0.0 | 17.9 | 80.1 | 0.0 | 16.2 | 85.8 |
| Na₂CO₃ (wt %) | 0.45 | 0.80 | 1.17 | 0.71 | 0.91 | 1.35 |
| NaOH (wt %) | 1.15 | 0.98 | 1.03 | 1.05 | 0.92 | 1.23 |
| Δ(Na₂CO₃ + NaOH) (%) | 0.0 | 63.0 | 149.6 | 0.0 | 15.8 | 107.3 |
| 2θ₍₀₀₃₎ | 16.531 | 16.528 | 16.525 | 16.519 | 16.518 | 16.512 |
| | Example 9 | | | Example 10 | | |
| Time (h) | 0 | 1 | 6 | 0 | 1 | 6 |
| H₂O (ppm) | 299 | 347 | 525 | 307 | 346 | 547 |
| ΔH₂O (%) | 0.0 | 16.1 | 75.6 | 0.0 | 12.7 | 78.2 |
| Na₂CO₃ (wt %) | 0.65 | 0.89 | 1.17 | 0.59 | 0.89 | 1.32 |
| NaOH (wt %) | 1.16 | 1.19 | 1.46 | 1.05 | 1.18 | 1.36 |
| Δ(Na₂CO₃ + NaOH) (%) | 0.0 | 39.5 | 105.9 | 0.0 | 63.2 | 153.3 |
| 2θ₍₀₀₃₎ | 16.521 | 16.520 | 16.518 | 16.525 | 16.523 | 16.522 |
| | Example 11 | | | Example 12 | | |
| Time (h) | 0 | 1 | 6 | 0 | 1 | 6 |
| H₂O (ppm) | 317 | 356 | 601 | 342 | 386 | 581 |
| ΔH₂O (%) | 0.0 | 12.3 | 89.6 | 0.0 | 12.9 | 69.9 |
| Na₂CO₃ (wt %) | 0.58 | 0.69 | 1.07 | 0.48 | 0.59 | 0.98 |
| NaOH (wt %) | 1.05 | 1.21 | 1.59 | 0.99 | 1.08 | 1.19 |
| Δ(Na₂CO₃ + NaOH) (%) | 0.0 | 34.2 | 135.9 | 0.0 | 32.0 | 124.4 |
| 2θ₍₀₀₃₎ | 16.527 | 16.525 | 16.524 | 16.517 | 16.516 | 16.515 |
| | Example 13 | | | Example 14 | | |
| Time (h) | 0 | 1 | 6 | 0 | 1 | 6 |
| H₂O (ppm) | 335 | 382 | 498 | 347 | 393 | 506 |
| ΔH₂O (%) | 0.0 | 14.0 | 48.7 | 0.0 | 13.3 | 45.8 |
| Na₂CO₃ (wt %) | 0.53 | 0.69 | 1.08 | 0.49 | 0.58 | 1.03 |
| NaOH (wt %) | 0.93 | 1.05 | 1.14 | 0.83 | 1.01 | 1.09 |
| Δ(Na₂CO₃ + NaOH) (%) | 0.0 | 43.1 | 126.4 | 0.0 | 40.1 | 141.5 |
| 2θ₍₀₀₃₎ | 16.519 | 16.518 | 16.517 | 16.525 | 16.523 | 16.521 |

| | Comparative Example 1 | | | Comparative Example 2 | | |
|---|---|---|---|---|---|---|
| Time (h) | 0 | 1 | 6 | 0 | 1 | 6 |
| H₂O (ppm) | 326 | 655 | 1301 | 322 | 588 | 1207 |
| ΔH₂O (%) | 0.0 | 100.9 | 299.1 | 0.0 | 82.6 | 274.8 |
| Na₂CO₃ (wt %) | 0.60 | 1.51 | 2.96 | 0.65 | 1.55 | 2.91 |
| NaOH (wt %) | 1.02 | 1.71 | 1.85 | 1.05 | 1.85 | 1.99 |
| Δ(Na₂CO₃ + NaOH) (%) | 0.0 | 219.3 | 474.7 | 0.0 | 214.7 | 437.2 |
| 2θ₍₀₀₃₎ | 16.521 | 16.513 | 16.501 | 16.519 | 16.515 | 16.501 |
| | Comparative Example 3 | | | Comparative Example 4 | | |
| Time (h) | 0 | 1 | 6 | 0 | 1 | 6 |
| H₂O (ppm) | 312 | 601 | 1101 | 311 | 593 | 1106 |
| ΔH₂O (%) | 0.0 | 92.6 | 252.9 | 0.0 | 90.7 | 255.6 |
| Na₂CO₃ (wt %) | 0.67 | 1.56 | 2.86 | 0.69 | 1.48 | 2.84 |
| NaOH (wt %) | 1.08 | 1.92 | 2.16 | 1.07 | 1.62 | 1.99 |
| Δ(Na₂CO₃ + NaOH) (%) | 0.0 | 210.6 | 426.9 | 0.0 | 165.9 | 397.6 |
| 2θ₍₀₀₃₎ | 16.519 | 16.515 | 16.496 | 16.520 | 16.517 | 16.498 |

| | Comparative Example 5 | | | Comparative Example 6 | | |
|---|---|---|---|---|---|---|
| Time (h) | 0 | 1 | 6 | 0 | 1 | 6 |
| H₂O (ppm) | 313 | 554 | 873 | 301 | 567 | 1117 |
| ΔH₂O (%) | 0.0 | 77.0 | 178.9 | 0.0 | 88.4 | 271.1 |
| Na₂CO₃ (wt %) | 0.72 | 1.57 | 2.81 | 0.68 | 1.52 | 2.87 |
| NaOH (wt %) | 1.11 | 1.75 | 2.01 | 1.01 | 1.66 | 1.83 |
| Δ(Na₂CO₃ + NaOH) (%) | 0.0 | 175.7 | 371.4 | 0.0 | 187.9 | 403.2 |
| 2θ₍₀₀₃₎ | 16.522 | 16.518 | 16.511 | 16.523 | 16.517 | 16.502 |

As can be seen from the data in Table 2, relative to the Comparative Examples 1-6, the cathode materials produced in Examples 1-8 with the preparation method provided by the present application have less water absorption amounts in air, and the conversion quantities of Na₂CO₃ and NaOH are even less, there is less amount of de-intercalated Na resulting from the reaction of the cathode material with the air and carbon dioxide in air, and the change of interlayer spacing is smaller, such that the peak position shift forward of the characteristic diffraction peak A of (003) crystal plane is not obvious.

In comparison with Example 1, Comparative Example 1 adopts a technical solution of directly sintering the precursor, the produced cathode material has a larger water absorption in air, and the conversion quantities of the Na₂CO₃ and NaOH are relatively large.

As can be seen from the comparison results of Example 1 and Comparative Examples 2-6, the water increment and the residual alkali conversion rate of the cathode materials are regulated and controlled by adjusting the conditions of the sintering process (i.e., the sintering temperature, the temperature-rise rate, and the sintering time).

### (3) Test of Electrochemical Properties

The present application tested the electrochemical properties of the sodium ion battery cathode materials prepared in the aforementioned Examples and Comparative Examples, including the first charge specific capacity of 0.1 C, the first discharge specific capacity of 0.1 C, rate capability, cycle stability, and volume energy density, the specific test results were shown in Table 3.

TABLE 3

| | | | | Capacity | |
|---|---|---|---|---|---|
| | | | | retention | |
| | | | | rate after | |
| | | First | | 80 charge | |
| | First charge | discharge | | and | Volume |
| | specific | specific | 1.0 C/ | discharge | energy |
| | capacity, | capacity, | 0.1 C, | cycles at | density, |
| | 0.1 C/mAh/g | 0.1 C/mAh/g | % | 25° C., % | Wh/L |
| Example 1 | 136.4 | 132.6 | 95.1 | 94.5 | 1459.3 |
| Example 2 | 132.3 | 129.5 | 94.5 | 93.9 | 1373.0 |
| Example 3 | 134.1 | 131.0 | 95.6 | 95.1 | 1372.2 |
| Example 4 | 132.1 | 129.1 | 94.2 | 93.2 | 1360.7 |
| Example 5 | 132.3 | 129.5 | 93.9 | 93.8 | 1348.1 |
| Example 6 | 136.2 | 132.5 | 94.8 | 94.1 | 1330.8 |
| Example 7 | 132.5 | 129.8 | 94.7 | 94.5 | 1424.4 |
| Example 8 | 136.1 | 132.4 | 94.9 | 94.4 | 1305.2 |
| Example 9 | 138.5 | 135.4 | 95.4 | 94.2 | 1481.7 |
| Example 10 | 135.7 | 132.0 | 95.2 | 94.5 | 1431.6 |
| Example 11 | 136.2 | 132.5 | 96.5 | 94.5 | 1403.8 |
| Example 12 | 136.5 | 132.8 | 95.1 | 95.9 | 1420.3 |
| Example 13 | 136.3 | 133.5 | 95.2 | 96.1 | 1407.1 |
| Example 14 | 136.8 | 133.9 | 95.1 | 95.9 | 1418.9 |
| Comparative | 132.4 | 129.1 | 92.1 | 86.1 | 1288.5 |
| Example 1 | | | | | |
| Comparative | 132.3 | 129.3 | 93.2 | 86.7 | 1286.7 |
| Example 2 | | | | | |
| Comparative | 130.3 | 126.5 | 92.5 | 87.1 | 1250.7 |
| Example 3 | | | | | |
| Comparative | 131.8 | 129.0 | 92.2 | 88.8 | 1275.6 |
| Example 4 | | | | | |
| Comparative | 130.9 | 128.1 | 92.4 | 89.5 | 1266.5 |
| Example 5 | | | | | |
| Comparative | 132.1 | 127.2 | 90.5 | 85.7 | 1289.4 |
| Example 6 | | | | | |

As shown in data in Table 3, the present application provides the sodium ion battery cathode materials, after the precursors are subjected to the sintering treatment with a specific sintering process, and in particular, the particle size distribution of the precursors is regulated and controlled to satisfy the condition 1≤(D₉₀−D₁₀)/D₅₀≤1.5, the obtained pre-sintered precursors have improved structural stability and reactivity; in addition, the cathode materials made from the pre-sintered precursors exhibit improved air stability and structural stability. The rate capability and the cycle stability of the sodium ion battery cathode material can be significantly improved, in particular, the compaction density and the volume energy density of the sodium ion cathode material can be further enhanced by further defining the average particle size D₅₀ and the particle size distribution K₉₀ of the precursor; moreover, the rate capability and the cycle stability of the sodium ion battery cathode material can be further improved by using the doped element.

It is apparent from the comparison results of Example 1 and Comparative Example 1 that after the precursor is subjected to the pre-sintering treatment, the produced cathode material has better rate capability and cycle stability. In other words, the pre-sintering scheme provided by the present application is conducive to improving the structural stability and reactivity of the material; compared to the sodium-electron cathode material directly made from the precursor without subjecting to the pre-sintering treatment, the sodium-electron cathode material prepared in the present application has excellent comprehensive properties combining the high capacity, high rate capacity, and long cycle stability.

The comparison results of Example 1 and Comparative Examples 2-3 show that the prepared cathode material has better rate capability, cycle stability, and air stability when the pre-sintering temperature falls within the preferred range.

As can be seen from the comparison between Example 1 and Comparative Example 4, when the pre-sintering time is within a preferred range, the structural stability of the sodium ion battery cathode material can be further enhanced, thereby improving the rate capability, cycle stability, and air stability of the sodium ion battery.

As can be seen from the comparison results of Example 1, Example 5, and Comparative Example 5, when the pre-sintering temperature-rise rate falls within the preferred range, the structural stability of the sodium ion battery cathode material can be further enhanced, thereby improving the rate capability, cycle stability, and air stability of the sodium ion battery.

The comparison result of Example 1 and Comparative Example 6 shows that the rate capability, cycle stability, and air stability of the sodium ion battery are more excellent after the precursor subjected to the two-stage temperature rise pre-sintering treatment, as compared to the precursor subjected to the one-stage temperature rise pre-sintering treatment.

As indicated by the comparison of test results of Example 1 and Example 3, the different kinds of doping elements in the sodium ion battery cathode material can further enhance the stability of the monocrystal structure, further improve the cycle stability and rate capability of the sodium ion battery cathode material.

As is apparent from the comparison of the test results of Example 1 and Example 8, when the particle size distribution of precursor is outside the preferred range, the compaction density of the prepared sodium ion battery cathode material will be significantly reduced, and the volumetric energy density is decreased.

As can be seen from the results of comparing the microcrystalline size ratio D_{A}/D_{B} and the value of the lattice cell parameter c value of the Examples and Comparative Examples, the cathode materials prepared in the preferred conditions and ranges have a microcrystalline size ratio D_{A}/D_{B} within the range of 1.3-2.5 and the c value selected from the range of 16-16.1 Å, and exhibit a superior rate capability and significantly improved air stability compared to the Comparative Examples.

The above content describes in detail the preferred embodiments of the present application, but the present application is not limited thereto. A variety of simple modifications can be made in regard to the technical solutions of the present application within the scope of the technical concept of the present application, including a combination of individual technical features in any other suitable manner, such simple modifications and combinations thereof shall also be regarded as the content disclosed by the present application, each of them falls into the protection scope of the present application.

What is claimed is:

1. A sodium-ion battery cathode material, wherein in an XRD spectrogram of the cathode material, the characteristic diffraction peak A of (003) crystal plane and the characteristic diffraction peak B of (104) crystal plane are arranged at 2θ of 15-19° and 39-44°, respectively;
wherein the microcrystalline size D_{A} of the characteristic diffraction peak A and the microcrystalline size D_{B} of the characteristic diffraction peak B satisfy the following condition: 1.3≤D_{A}/D_{B}≤2.5, wherein D_{A} and D_{B} correspond to the microcrystalline sizes of the (003) crystal plane and the (104) crystal plane in the perpendicular line direction, respectively.

2. The cathode material according to claim 1, wherein the cathode material satisfies at least one of the following:
the cathode material has an O3-type monocrystal structure, and the c value is selected from the range of 16-16.1 Å;
in an XRD spectrogram of the cathode material, the characteristic diffraction peak A has an angle 2θ within the range of 16.5±1°, and the characteristic diffraction peak B has an angle 2θ within the range of 41.5±1°; or
the microcrystalline size D_{A} of the characteristic diffraction peak A and the microcrystalline size D_{B} of the characteristic diffraction peak B satisfy the following condition: 1.3≤D_{A}/D_{B}≤2.

3. The cathode material according to claims 1, wherein the cathode material has the composition represented by formula I: Naₐ(NiₓFe_{y}Mn_{z}MₘM′ₙ)O₂ (I),
in formula I, 0.8≤a≤1.1, 0≤x≤0.5, 0≤y≤0.5, 0≤z≤0.5, 0≤m≤0.5, 0≤n≤0.2, 0.05≤m+n≤0.5, m and n are not simultaneously 0, x+y+z+m+n=1; M and M′ are each independently at least one element selected from the group consisting of Li, Cu, Co, V, Cr, Ti, Mg, Sn, Zn, Al, Zr, Sr, Nb, B, Y, W, and La;
preferably, in formula I, 0.85≤a≤1.05; further preferably, 0.93≤a≤1.03;
preferably, in formula I, M is at least one element selected from the group consisting of Cu, Co, V, Cr, Ti, Mg, Sn, Zn, Al, Zr, Nb, Y, W, and La, and M′ is at least one element selected from the group consisting of Li, Al, Mg, Ti, Zr, Sr, La, Nb, B, and W;
further preferably, M and M′ are different.

4. The cathode material according to claim 1, wherein the cathode material satisfies at least one of the following:
an average partice size D₅₀ of the cathode material is within the range of 7-20 μm, preferably within the range of 8-16 μm, more preferably within the range of 9-12 μm; the particle size distribution of the cathode material satisfies the following condition: 1.2≤(D₉₀-D₁₀)/D₅₀≤1.8, preferably 1.4≤(D₉₀−D₁₀)/D₅₀≤1.6;
the compaction density of the cathode material is within the range of 3-3.6 g/cm³, preferably within the range of 3.3-3.6 g/cm³;
the water increment of the cathode material satisfies the following condition: 0%≤Δ(H₂O)≤120%, wherein Δ(H₂O)=H₂O(tₓ−t₀)/H₂O(t₀), 0 h<tₓ≤6 h, t₀=0 h; preferably 0%≤Δ(H₂O)≤100%; or
the residual alkali conversion rate of the cathode material satisfies the following condition: 0%≤Δ(Na₂CO₃+NaOH)≤200%, wherein Δ(Na₂CO₃+NaOH)=Na₂CO₃(tₓ−t₀)/Na₂CO₃(t₀)+NaOH(tₓ−t₀)/NaOH(t₀), 0 h<tₓ≤6 h, t₀=0 h;
preferably 0%≤Δ(Na₂CO₃+NaOH)≤150%.

5. A method of preparing a sodium ion battery cathode material, comprising the following steps:
(1) pre-sintering a precursor having the composition represented by formula (II) Ni_{α}Fe_{β}Mn_{γ}M_{δ}OₐH_{b} to obtain a pre-sintered precursor;
(2) mixing and calcinating the pre-sintered precursor, a Na source, and an optional M′-containing dopant to obtain a cathode material; wherein M and M′ in the cathode material are not simultaneously 0;
wherein in formula II, 0≤α≤0.5, 0≤β≤0.5, 0≤γ≤0.5, 0≤δ≤0.5, 1≤a≤2, 0≤b≤2, α+β+γ+δ=1, M and M′ are each independently at least one element selected from the group consisting of Li, Cu, Co, V, Cr, Ti, Mg, Sn, Zn, Al, Zr, Sr, Nb, B, Y, W, and La;
wherein the pre-sintering process comprises first temperature rise stage, second temperature rise stage and heat preservation stage, the conditions of the first temperature rise stage comprise: raising the temperature to T₁ at a temperature-rise rate v₁ in an oxygen-depleted atmosphere having an oxygen concentration less than or equal to 10 vol %; the conditions of the second temperature rise stage comprise: raising the temperature to T₂ at a temperature-rise rate v₂ in an oxygen-depleted atmosphere having an oxygen concentration less than or equal to 20 vol %; the conditions of the heat preservation stage comprise: preserving heat within the temperature range of (T₂−10)≤T≤(T₂+10) for a time t; wherein v₁ is selected from the range of 5-10° C./min, v₂ is selected from the range of 1-3° C./min, T₁ is selected from the range of 200-300° C., T₂ is selected from the range of 450-750° C.; t is selected from the range of 3-10 h.

6. The method according to claim 5, wherein in step (1), the method satisfies at least one of the following:
an average partice size D₅₀ of the precursor is within the range of 7.5-8.5 μm, and the particle size distribution satisfies the following condition: 1≤(D₉₀−D₁₀)/D₅₀≤1.5; the precursor has a tap density within the range of 0.7-1.5 g/cm³ and a specific surface area within the range of 30-100 m²/g;
the precursor is produced with the following method: subjecting a mixed metal salt solution containing a Ni source, a Fe source, a Mn source, and an M source, a precipitant solution, and a complexing agent solution to co-precipitation reaction in a non-oxidizing atmosphere to obtain the precursor; or
the precursor and the pre-sintered precursor each independently have a spherical structure.

7. The method according to claim 5, wherein in step (2), the method satisfies at least one of the following:
the used amounts of the pre-sintered precursor and the Na source satisfy the condition n(Ni+Fe+Mn+M):n(Na)=(0.8-1.1):1, preferably satisfy the condition n(Ni+Fe+Mn+M):n(Na)−(0.85-1.05):1, more preferably satisfy the condition n(Ni+Fe+Mn+M):n(Na)=(0.93-1.03):1;
the used amount of component M satisfies the condition: n(M′):n(Ni+Fe+Mn+M+M′)=(0-0.2):1; or
the dopant is at least one selected from the group consisting of oxides, phosphates, carbonates, fluorides, chlorides, hydroxides, and silicides that contain the M′ element, preferably is at least one selected from the group consisting of Li₂CO₃, Al₂O₃, AlPO₄, AlCl₃, MgO, Mg₃(PO₄)₂, MgCO₃, MgSi₂, MgF₂, MgCl₂, TiO₂, ZrO, Zr(HPO₄)₂, ZrSi₂, Sr(OH)₂, SrCO₃, SrSi₂, SrF₂, SrCl₂, La₂O₃, Nb₂O₅, B₂O₃, and WO₃.

8. The method according to claim 5, wherein in step (2), the method satisfies at least one of the following:
the calcination conditions comprise: a temperature selected from the range of 900-1,100° C.; a time selected from the range of 5-15 h; or
the calcination process comprises temperature rise stage I, temperature rise stage II, and constant temperature stage, the difference between the oxygen concentration in the atmosphere of the temperature rise stage II and the oxygen concentration in the atmosphere of the temperature rise stage I is within the range of 10-100 vol %, and the difference between the temperature-rise rate of the temperature rise stage I and the temperature rise rate of the temperature rise stage II is within the range of 2-15° C./min;
preferably, the conditions of the temperature rise stage I comprise: raising the temperature to T₁′ at a temperature-rise rate v₁′ in an oxygen-depleted atmosphere having an oxygen concentration less than or equal to 10 vol %;
the conditions of the temperature rise stage II comprise: raising the temperature to T₂′ at a temperature-rise rate v₂′ in an atmosphere having an oxygen concentration larger than or equal to 20 vol %; the conditions of the constant temperature stage comprise: preserving heat within the temperature range of (T₂′−10)≤T′≤(T₂′+10) for a time t′; wherein v₁′≥3° C./min, v₂′≤1° C./min, T₁′ is selected from the range of 600-800° C., T₂′ is selected from the range of 900-1,100° C.; t′ is selected from the range of 5-15 h.

9. The method according to claim 5, wherein the cathode material has the composition represented by formula I: Naₐ(NiₓFe_{y}Mn_{z}MₘM′ₙ)O₂ (I),
in formula I, 0.8≤a≤1.1, 0≤x≤0.5, 0≤y≤0.5, 0≤z≤0.5, 0≤m≤0.5, 0≤n≤0.2, 0.05≤m+n≤0.5, m and n are not simultaneously 0, x+y+z+m+n=1; M and M′ are each independently at least one element selected from the group consisting of Li, Cu, Co, V, Cr, Ti, Mg, Sn, Zn, Al, Zr, Sr, Nb, B, Y, W, and La;
preferably, in formula I, 0.85≤a≤1.05; further preferably, 0.93≤a≤1.03;
preferably, in formula I, M is at least one element selected from the group consisting of Cu, Co, V, Cr, Ti, Mg, Sn, Zn, Al, Zr, Nb, Y, W, and La, and M′ is at least one element selected from the group consisting of Li, Al, Mg, Ti, Zr, Sr, La, Nb, B, and W; further preferably, M and M′ are different.

10. A sodium ion battery, wherein the sodium ion battery comprises the cathode material according to claim 1.
